(19) United States
(12) Patent Application Publication
(10) Pub. No.: US 2025/0353699 A1
(43) Pub. Date: Nov. 20, 2025

(54) SHEET BINDING DEVICE AND SHEET POST-PROCESSING APPARATUS INCLUDING SAME

(71) Applicant: KYOCERA Document Solutions Inc., Osaka (JP)

(72) Inventor: Seiichi SHIRASAKI, Osaka (JP)

(73) Assignee: KYOCERA Document Solutions Inc., Osaka (JP)

(21) Appl. No.: 19/197,552

(22) Filed: May 2, 2025

(30) Foreign Application Priority Data
May 15, 2024 (JP) 2024-079291

(51) Int. Cl. B65H 37/04; B42C 1/12; B42C 3/00; B65H 31/34

(52) U.S. Cl. CPC B65H 37/04; B42C 1/12; B65H 31/34; B42C 3/00; B65H 2301/4222; B65H 2301/51611; B65H 2801/24

(57) ABSTRACT

A sheet binding device includes a processing tray, a movable reference plate, a stapling portion, a movement portion, a slide member, and a slide spring. When the stapling portion in an inclined state is moved from a reference position to a stapling position, the movable reference plate moves from an initial position, and when orientation of the stapling portion is shifted from the inclined state to a parallel state, the movable reference plate returns to the initial position. When the orientation of the stapling portion is shifted from the parallel state to the inclined state while the stapling portion is moved from the stapling position to the reference position, the movable reference plate moves from the initial position, and the stapling-side engagement portion separates from the movable engagement member, thereby causing the movable reference plate to return to the initial position.

### INCORPORATION BY REFERENCE

This application is based on and claims the benefit of priority from Japanese Patent Application No. 2024-079291 filed on May 15, 2024, the contents of which are hereby incorporated by reference.

### BACKGROUND

The present disclosure relates to a sheet binding device that performs a binding process on a plurality of sheets having undergone image formation performed by an image forming apparatus, and to a sheet post-processing apparatus including the same.

Sheet post-processing apparatuses are known that perform various types of post-processing, such as a binding process of stacking, into a sheet bundle, a plurality of sheets on which images have been formed by an image forming apparatus such as a copier, a printer, etc., and binding the sheet bundle with a staple needle, a punch hole forming process of forming a punch hole (punching) with a punch hole forming device, a folding process of forming a fold on a sheet, etc. To perform the binding process on sheet bundles, it is essential to accurately align sheets of various sizes to predetermined binding positions. To achieve this, a widely used configuration guides a sheet so that its rear end strikes a reference plate (a rear end stopper), which regulates positioning of the sheet in a conveyance direction thereof, thereby aligning the sheet.

With this configuration, however, if the reference plate, which a sheet is caused to strike, is not located at an appropriate position corresponding to a sheet size in a direction (a sheet width direction) orthogonal to the conveyance direction, it may result in degraded alignment. This issue has been addressed, for example, by providing more reference plates or by giving a reference plate a wider width for contacting a sheet. However, when a stapler is moved to drive a staple needle through sheets at a predetermined position thereon, the stapler may come to a position where it lies across the reference plate, or may disturb sheet alignment.

### SUMMARY

According to one aspect of the present disclosure, a sheet binding device includes a processing tray, a movable reference plate, a stapling portion, a movement portion, a slide member, and a slide spring. To the processing tray, a plurality of sheets are conveyed along a predetermined sheet entry direction to be stacked thereon. The movable reference plate is disposed at a predetermined initial position at which the movable reference plate is capable of aligning the sheets by abutting edges of the sheets on a downstream side in an alignment direction that is opposite to the sheet entry direction, and the movable reference plate is movable from the initial position in a sheet width direction that is orthogonal to the sheet entry direction. The stapling portion is disposed opposite to the edges of the sheets, and performs a stapling process of binding the plurality of sheets stacked on the processing tray with a staple needle at a predetermined position. The movement portion causes the stapling portion to move, along the edges of the sheets, to a reference position that is located outward of the initial position in the sheet width direction and to at least one stapling position that is located inward of the initial position in the sheet width direction and at which the staple process is performed. The movement portion is capable of shifting orientation of the stapling portion to an inclined state inclined with respect to the edges of the sheets and to a parallel state parallel to the edges of the sheets. The slide member has the movable reference plate mounted thereon, and is reciprocatable along the sheet width direction. The slide spring biases the slide member in a direction in which the movable reference plate approaches the initial position. The slide member includes a movable engagement member that makes contact with a stapling-side engagement portion of the stapling portion when the stapling portion moves between the reference position and the stapling position. In a state in which the movable reference plate is disposed at the initial position, when the stapling portion is brought into the inclined state and moved from the reference position to the stapling position, the stapling-side engagement portion presses the movable engagement member, thereby causing the movable reference plate to move with the slide member inward in the sheet width direction against a biasing force of the slide spring. When the orientation of the stapling portion is shifted from the inclined state to the parallel state before the stapling portion reaches the stapling position, the stapling-side engagement portion separates from the movable engagement member, thereby causing the movable reference plate to move with the slide member outward in the sheet width direction due to the biasing force of the slide spring, so as to return to the initial position. When the orientation of the stapling portion is shifted from the parallel state to the inclined state while the stapling portion is moved from the stapling position to the reference position, the stapling-side engagement portion presses the movable engagement member, thereby causing the movable reference plate to move with the slide member inward from the initial position in the sheet width direction against the biasing force of the slide spring. Due to movement of the stapling portion to the reference position, the stapling-side engagement portion separates from the movable engagement member, thereby causing the movable reference plate to move with the slide member outward in the sheet width direction due to the biasing force of the slide spring, so as to return to the initial position.

### BRIEF DESCRIPTION OF THE DRAWINGS

FIG. 1 is a schematic diagram showing a configuration of an image forming system constituted of a sheet post-processing apparatus including a sheet binding unit according to one embodiment of the present disclosure and an image forming apparatus to which the sheet post-processing apparatus is coupled.

FIG. 2 is a side sectional view schematically showing a configuration of the sheet post-processing apparatus including the sheet binding unit of the present embodiment.

FIG. 3 is a perspective view of the sheet binding unit of the present embodiment.

FIG. 4 is a side view of the sheet binding unit of the present embodiment.

FIG. 5 is a side view schematically showing a movement portion for moving a stapling portion.

FIG. 6 is a side view of a central reference plate, a first reference plate, and a second reference plate of the sheet binding unit as seen from a downstream side in an alignment direction.

FIG. 7 is a plan view of a state in which the first reference plate is attached to a first slide member, as seen from a side of the first reference plate.

FIG. 8 is a plan view showing an inner structure of the first slide member.

FIG. 9 is a plan view showing an inner structure of a second slide member.

FIG. 10 is a plan view of a state in which the first slide member and the second slide member are couped to each other, as seen from the side of the first reference plate, with a slide spring in a contracted state.

FIG. 11 is a plan view of the state in which the first slide member and the second slide member are couped to each other, as seen from the side of the first reference plate, with the slide spring in an expanded state.

FIG. 12 is a perspective view of the stapling portion as seen from a side of a processing tray.

FIG. 13 is a plan view of the sheet binding unit as seen from above, showing a state in which the stapling portion is disposed at a reference position.

FIG. 14 is a plan view of the sheet binding unit as seen from above, showing a stapling position of the stapling portion for performing oblique binding on A-sized sheets.

FIG. 15 is a plan view of the sheet binding unit as seen from above, showing a stapling position of the stapling portion for performing oblique binding on B-sized sheets.

FIG. 16 is a partial enlarged view showing insides of the first and second slide members of the first reference plate in the state shown in FIG. 15.

FIG. 17 is a partial enlarged view showing the insides of the first and second slide members of the first reference plate in a state during movement of the stapling portion from the reference position to the stapling position for performing parallel binding on B-sized sheets.

FIG. 18 is a plan view of the sheet binding unit as seen from above, showing a standby position of the stapling portion when receiving sheets in a case of performing parallel binding on B-sized sheets.

FIG. 19 is a diagram showing a state in which, while the stapling portion returns from an apparatus center to the reference position, a stapling-side engagement portion has made contact with an engagement protrusion of a second engagement member.

FIG. 20 is a diagram showing a state in which, due to movement of the stapling portion from the state shown in FIG. 19, the second engagement member has started to rotate.

FIG. 21 is a diagram showing a state in which the stapling portion has further moved from the state shown in FIG. 20 toward an apparatus front side until the stapling portion and the first reference plate overlap each other.

FIG. 22 is a diagram showing a state in which the stapling portion has obliquely rotated from the state shown in FIG. 21.

FIG. 23 is a diagram showing a state in which the stapling portion has obliquely rotated from the state shown in FIG. 22.

### DETAILED DESCRIPTION

### [1. Configuration of Image Forming System]

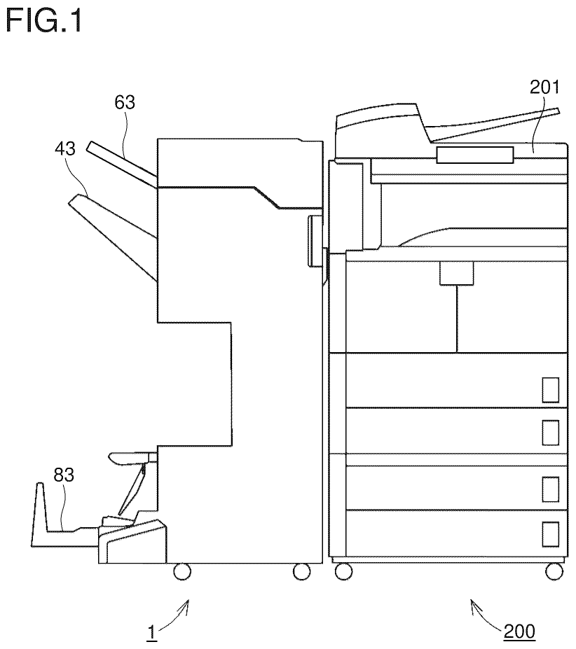

Hereinafter, an embodiment of the present disclosure will be described in detail with reference to the accompanying drawings. FIG. 1 is a schematic diagram showing a configuration of an image forming system constituted of a sheet post-processing apparatus 1 including a sheet binding unit 92 according to one embodiment of the present disclosure and an image forming apparatus 200 to which the sheet post-processing apparatus 1 is coupled.

The image forming apparatus 200 prints an image on a sheet (paper) based on image data externally inputted via an unillustrated network communication portion or image data read by an image reading portion 201 disposed in an upper part of the image forming apparatus 200.

The sheet post-processing apparatus 1 is detachably coupled to a side surface of the image forming apparatus 200. The sheet post-processing apparatus 1 performs post-processing including a punch hole forming process, a binding process, and the like on sheets having been subjected to image formation (printing) by the image forming apparatus 200. Note that the sheet post-processing apparatus 1 is not limited to one that performs post-processing on a sheet automatically conveyed from the image forming apparatus 200, but it may be one that conveys, on its own, a sheet set by a user on an unillustrated tray to a position at which it can perform post-processing, and then performs post-processing on the sheet.

### [2. Configuration of Sheet Post-Processing Apparatus]

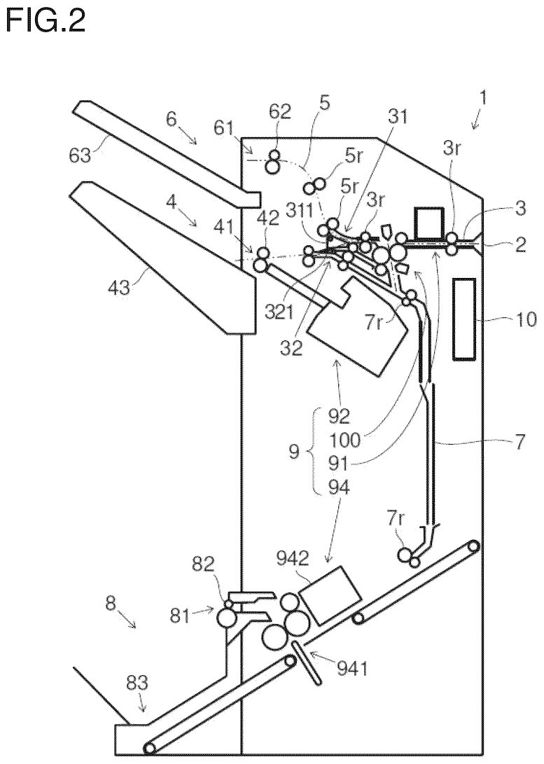

FIG. 2 is a side sectional view schematically showing a configuration of the sheet post-processing apparatus 1 including the sheet binding unit 92 of the present embodiment. As shown in FIG. 2, the sheet post-processing apparatus 1 includes a sheet inlet port 2, a first sheet conveyance path 3, a first sheet discharge portion 4, a second sheet conveyance path 5, a second sheet discharge portion 6, a third sheet conveyance path 7, a third sheet discharge portion 8, a post-processing portion 9, and a post-processing control portion (a control portion) 10.

The sheet inlet port 2 is an opening provided in a side surface of the sheet post-processing apparatus 1 that faces the image forming apparatus 200. A sheet conveyed from the image forming apparatus 200 toward the sheet post-processing apparatus 1 passes through the sheet inlet port 2 to be conveyed into the sheet post-processing apparatus 1.

The first sheet conveyance path 3 extends substantially in a horizontal direction from the sheet inlet port 2 to the first sheet discharge portion 4, in a direction away from the image forming apparatus 200 (in a leftward direction in FIG. 2). Note that a direction from the sheet inlet port 2 toward the first sheet discharge portion 4 is referred to as a sheet conveyance direction in the first sheet conveyance path 3. The sheet inlet port 2 is positioned at an upstream end of the first sheet conveyance path 3 in the sheet conveyance direction. The first sheet conveyance path 3 includes a plurality of conveyance roller pairs 3r, by which a sheet conveyed from the sheet inlet port 2 into the sheet post-processing apparatus 1 is conveyed toward a downstream side in the sheet conveyance direction.

The first sheet discharge portion 4 is provided at a side surface of the sheet post-processing apparatus 1 that is opposite to the side surface thereof that faces the image forming apparatus 200. The first sheet discharge portion 4 is disposed at a downstream end of the first sheet conveyance path 3 in the sheet conveyance direction. The first sheet discharge portion 4 includes a first discharge port 41, a first discharge roller pair 42, and a first discharge tray 43. The first discharge port 41 is positioned at the downstream end of the first sheet conveyance path 3 in the sheet conveyance direction. The first discharge roller pair 42 is disposed at the first discharge port 41. The first discharge tray 43 is positioned downstream of the first discharge port 41 in the sheet conveyance direction. A sheet conveyed along the first sheet conveyance path 3 to reach the first discharge port 41 is then discharged by the first discharge roller pair 42 onto the first discharge tray 43 through the first discharge port 41. The first discharge tray 43 is one of the final discharge destinations for a sheet having been subjected to post-processing by the sheet post-processing apparatus 1.

The second sheet conveyance path 5 branches from a first branching portion (a branching portion) 31 on the first sheet conveyance path 3 to reach the second sheet discharge portion 6 by extending laterally in the direction away from the image forming apparatus 200 (in the leftward direction in FIG. 2) and upward. The first branching portion 31 is disposed downstream of a punching portion 91 with respect to the sheet conveyance direction in the first sheet conveyance path 3. Note that a direction from the first branching portion 31 toward the second sheet discharge portion 6 is referred to as a sheet conveyance direction in the second sheet conveyance path 5. The first branching portion 31 is positioned at an upstream end of the second sheet conveyance path 5 in the sheet conveyance direction. The second sheet conveyance path 5 includes a plurality of conveyance roller pairs 5r, and redirects a sheet conveyed on the first sheet conveyance path 3 at the first branching portion 31 to convey the sheet toward the second sheet discharge portion 6.

The first branching portion 31 includes a first switching guide 311. The first switching guide 311 pivots to a position for guiding a sheet, conveyed from the sheet inlet port 2 on the first sheet conveyance path 3, to the first discharge port 41 along the first sheet conveyance path 3, and to a position for redirecting the sheet conveyed on the first sheet conveyance path 3 to guide the sheet into the second sheet conveyance path 5. Furthermore, the first switching guide 311 pivots to a position for guiding a sheet into the second sheet conveyance path 5 after the sheet has been subjected to a folding process and then passed through a later-mentioned second folding conveyance path 106. The first switching guide 311 is connected to a drive mechanism (unillustrated), and has an operation thereof controlled by the post-processing control portion 10.

The second sheet discharge portion 6 is provided at the side surface of the sheet post-processing apparatus 1 opposite to the side surface thereof facing the image forming apparatus 200, so as to be above the first sheet discharge portion 4. The second sheet discharge portion 6 is disposed at a downstream end of the second sheet conveyance path 5 in the sheet conveyance direction. The second sheet discharge portion 6 includes a second discharge port 61, a second discharge roller pair 62, and a second discharge tray 63.

The second discharge port 61 is positioned at the downstream end of the second sheet conveyance path 5 in the sheet conveyance direction. The second discharge roller pair 62 is disposed at the second discharge port 61. The second discharge tray 63 is positioned downstream of the second discharge port 61 in the sheet conveyance direction. A sheet conveyed on the second sheet conveyance path 5 to reach the second discharge port 61 is then discharged by the second discharge roller pair 62 onto the second discharge tray 63 through the second discharge port 61. The second discharge tray 63 is one of the final discharge destinations for a sheet having been subjected to post-processing by the sheet post-processing apparatus 1. Further, onto the second discharge tray 63, a sheet not to be subjected to post-processing, a small-sized sheet, etc., are also discharged.

The third sheet conveyance path 7 branches from a second branching portion 32 on the first sheet conveyance path 3 to extend downward to the third sheet discharge portion 8. Note that a direction from the second branching portion 32 toward the third sheet discharge portion 8 is referred to as a sheet conveyance direction in the third sheet conveyance path 7. The second branching portion 32 is positioned downstream of the first branching portion 31 with respect to the sheet conveyance direction of the first sheet conveyance path 3, at an upstream end of the third sheet conveyance path 7 in the sheet conveyance direction. The third sheet conveyance path 7 includes a plurality of conveyance roller pairs 7r, and redirects a sheet, conveyed on the first sheet conveyance path 3, at the second branching portion 32 to convey the sheet toward the third sheet discharge portion 8.

The second branching portion 32 includes a second switching guide 321. The second switching guide 321 pivots to a position for guiding a sheet, conveyed on the first sheet conveyance path 3 from the sheet inlet port 2, along the first sheet conveyance path 3 to the first discharge port 41, and to a position for guiding a sheet, having been switched back after being conveyed on the first sheet conveyance path 3 from the sheet inlet port 2 to pass through the second branching portion 32, to the third sheet conveyance path 7. The second switching guide 321 is connected to a drive mechanism (unillustrated), and has an operation thereof controlled by the post-processing control portion 10.

The third sheet discharge portion 8 is provided at the side surface of the sheet post-processing apparatus 1 opposite to the side surface thereof facing the image forming apparatus 200, so as to be below the first sheet discharge portion 4 (near a lower end part of the sheet post-processing apparatus 1). The third sheet discharge portion 8 includes a third discharge port 81, a third discharge roller pair 82, and a third discharge tray 83.

The third discharge port 81 is positioned at a downstream end of the third sheet conveyance path 7 in the sheet conveyance direction. The third discharge roller pair 82 is disposed at the third discharge port 81. The third discharge tray 83 is positioned downstream of the third discharge port 81 in the sheet conveyance direction. A sheet conveyed on the third sheet conveyance path 7 to reach the third discharge port 81 is then discharged by the third discharge roller pair 82 onto the third discharge tray 83 through the third discharge port 81. The third discharge tray 83 is one of the final discharge destinations for a sheet having been subjected to post-processing by the sheet post-processing apparatus 1.

The post-processing portion 9 performs a predetermined type of post-processing with respect to a sheet having been subjected to image formation by the image forming apparatus 200 and then conveyed into the sheet post-processing apparatus 1. The post-processing portion 9 includes the punching portion 91, a sheet binding unit 92, a sheet folding unit 93, and a bookbinding portion 94.

The punching portion 91 is disposed on the first sheet conveyance path 3 so as to be downstream of, and immediately close to, the sheet inlet port 2. The punching portion 91 performs a punching process with respect to a sheet conveyed on the first sheet conveyance path 3, thereby forming a punch hole in the sheet.

The sheet binding unit 92 is disposed, with respect to the sheet conveyance direction of the first sheet conveyance path 3, upstream of and immediately close to the first sheet discharge portion 4. The sheet binding unit 92 performs a stapling process (the binding process) with respect to a sheet bundle formed by stacking a plurality of sheets, and thereby binds the sheet bundle. A detailed configuration of the sheet binding unit 92 will be described later.

The sheet folding unit 93 is disposed, with respect to the sheet conveyance direction of the first sheet conveyance path 3, downstream of the punching portion 91 but upstream of the sheet binding unit 92. The sheet folding unit 93 performs the folding process with respect to a single sheet, and thereby forms a fold on the sheet. The sheet folding unit 93 is capable of performing, on a single sheet, the folding process, such as half-fold, Z-hold, outer three-fold, inner three-fold, or the like.

The bookbinding portion 94 is disposed upstream of the third sheet discharge portion 8 with respect to the sheet conveyance direction of the third sheet conveyance path 7 so as to be immediately close to the third sheet discharge portion 8. The bookbinding portion 94 includes a center-folding portion 941 and a center-binding portion 942. The bookbinding portion 94 performs a center-folding process and a center-binding process for folding and binding a sheet bundle, formed by stacking a plurality of sheets, substantially at a center thereof in the sheet conveyance direction, and thereby forms a booklet.

The post-processing control portion 10 includes a CPU, a storage portion, and other electronic circuits and components (of which none is illustrated). The post-processing control portion 10 is connected to a main body control portion of the image forming apparatus 200 (see FIG. 1) in a communicable manner. Upon receiving a command from the main body control portion, based on control programs and data stored in the storage portion, the post-processing control portion 10, by using the CPU, controls operations of individual components provided in the sheet post-processing apparatus 1, and performs processing related to functions of the sheet post-processing apparatus 1. The first sheet conveyance path 3, the first sheet discharge portion 4, the second sheet conveyance path 5, the second sheet discharge portion 6, the third sheet conveyance path 7, the third sheet discharge portion 8, and the post-processing portion 9 each individually receive commands from the post-processing control portion 10 and perform the post-processing with respect to a sheet in cooperation with each other. Note that functions of the post-processing control portion (a control portion) 10 may be performed by the main body control potion of the image forming apparatus 200 instead.

### [3. Configuration of Sheet Binding Unit]

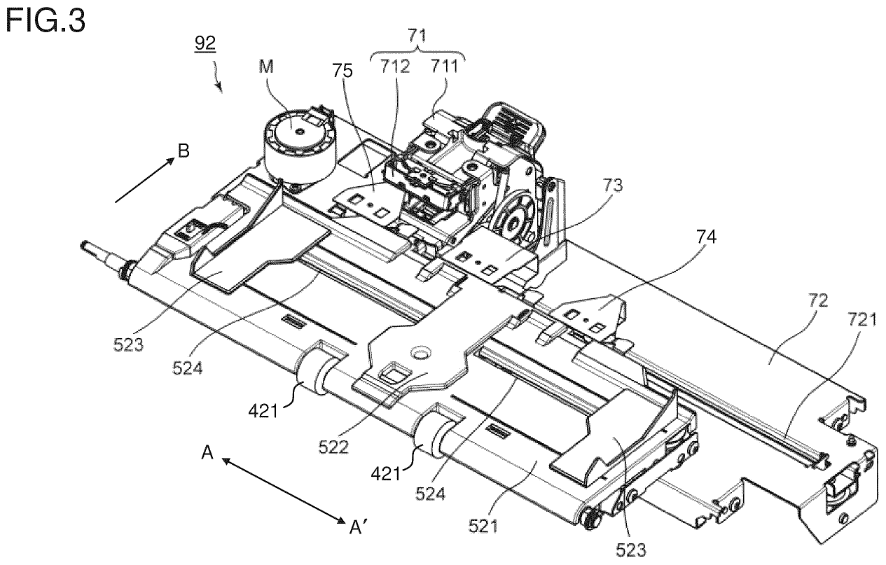

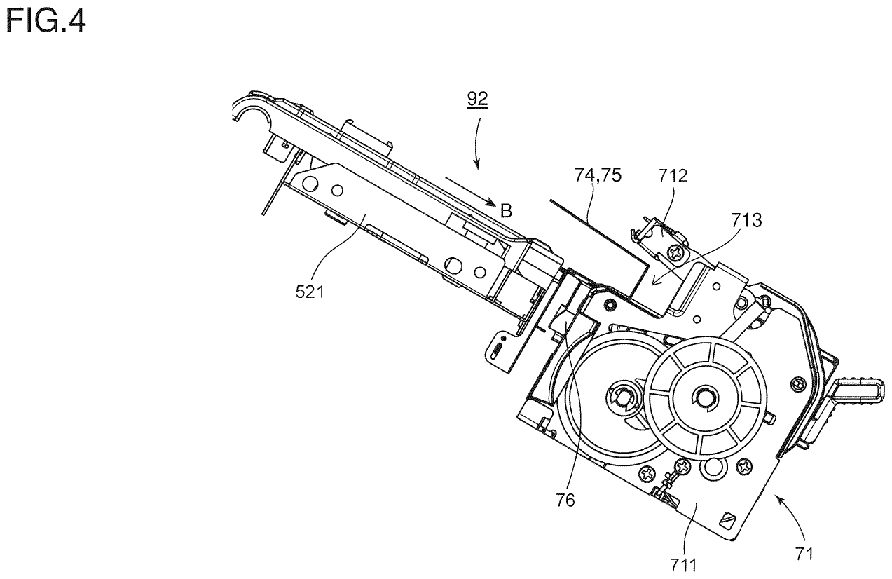

Next, a description will be given of a configuration of the sheet binding unit 92, using FIGS. 3 and 4. FIG. 3 is a perspective view of the sheet binding unit 92 of the present embodiment. FIG. 4 is a side view of the sheet binding unit 92.

As shown in FIG. 3, the sheet binding unit 92 includes a processing tray 521, the stapling portion 71, a central reference plate 73 (a secured reference plate), a first reference plate 74 (a movable reference plate), and a second reference plate 75 (a movable reference plate).

The processing tray 521 is a rectangular tray extending in a sheet width direction (an arrow-AA′ direction) and in a sheet entry direction. On the processing tray 521, a plurality of sheets S (a sheet bundle) are stacked, which are to be subjected to the stapling process. In this case, the sheets S are conveyed along the sheet entry direction (leftward in FIG. 4) onto the processing tray 521 and then switched back to be aligned along an alignment direction (a direction opposite to the sheet entry direction), which is a lower right direction (an arrow-B direction) in FIG. 4. The sheet bundle having been subjected to the staple process is eventually sent out by the first discharge roller pair 42 (see FIG. 2) toward a direction (an upper left direction in FIG. 4) opposite to the alignment direction mentioned above, so as to be discharged onto the first discharge tray 43 (see FIG. 2). On a downstream side (a lower left side in FIG. 3) of the processing tray 521 in the sheet entry direction, a rollers 421 is supported as a lower constituting the first discharge roller pair 42.

The processing tray 521 includes a tray central portion 522 and width regulation members 523. The tray central portion 522 is disposed, on an upper surface part of the processing tray 521, in a central part in the sheet width direction. The tray central portion 522 is a thin plate member secured to the processing tray 521 at a slight height.

The width regulation members 523 are disposed in pair so as to sandwich the tray central portion 522 therebetween in the sheet width direction. The width regulation members 523 regulate a position of a sheet S conveyed into the processing tray 521 in the sheet width direction. The width regulation members 523 are, similarly to the tray central portion 522, each made of a thin plate member, having a side wall standing upward at an end part in the sheet width direction. In the processing tray 521, a guide groove 524 is formed to extend along the sheet width direction. The width regulation members 523 are reciprocatable along the guide groove 524 in the sheet width direction via a drive mechanism (unillustrated) such as a rack and pinion gear. In the present embodiment, every time a sheet is conveyed onto the processing tray 521, the width regulation members 523 are caused by the drive mechanism to reciprocate. As a result, sheets S stacked on the processing tray 521 are aligned in the sheet width direction.

The stapling portion 71 is disposed opposite to an end edge of the processing tray 521 on a downstream side (a rear right side in FIG. 3, a lower right side in FIG. 4) with respect to the alignment direction of sheets S (the arrow-B direction). The stapling portion 71 is movable along the end edge of the processing tray 521 in the sheet width direction (the arrow-AA′ direction) that is orthogonal to the alignment direction, and performs the stapling process with respect to a bundle of sheets S.

As shown in FIG. 4, the stapling portion 71 includes a stapling main body 711 and a stapling movable portion 712. The stapling main body 711 is a main body of the stapling portion 71, and holds therein a plurality of staple needles (unillustrated). The stapling movable portion 712 is movable upward and downward, and drives a staple needle into a bundle of sheets S. Between the stapling main body 711 and the stapling movable portion 712, a concave portion 713 is formed into which end edges of sheets S enter.

The central reference plate 73 is secured to the processing tray 521 so as to be opposite to an end part of the tray central portion 522 on a downstream side (an upper right side in FIG. 3, a lower right side in FIG. 4) in the alignment direction. The central reference plate 73 is, in a sectional view taken along a direction orthogonal to the sheet width direction, substantially U-shaped, open to an upstream side (an upper left side in FIG. 4) in the alignment direction. The central reference plate 73 abuts the end edges of sheets S conveyed onto the processing tray 521, so as to align the sheets S in the sheet entry direction.

The first reference plate 74 and the second reference plate 75 are disposed on the processing tray 521 with a distance therebetween in the sheet width direction, so as to sandwich the central reference plate 73. The first reference plate 74 and the second reference plate 75, together with the central reference plate 73, abut rear edges of incoming sheets S, and thereby align the sheets S in the sheet entry direction. The first reference plate 74 and the second reference plate 75 are each supported by an unillustrated guide mechanism so as to be slidable in the sheet width direction. The first reference plate 74 and the second reference plate 75, as well as the central reference plate 73, are substantially U-shaped. The first reference plate 74 and the second reference plate 75 allow opposite end sides of the sheets S in the sheet width direction to be stably aligned respectively in the sheet entry direction. Note that, as seen from the central reference plate 73, a side of the first reference plate 74 is an apparatus front side, and a side of the second reference plate 75 is an apparatus rear side. Thus, in the following descriptions, of the sheet width direction, an arrow-A direction may also be referred to as the apparatus rear side, and the arrow-A′ direction may be referred to as the apparatus front side.

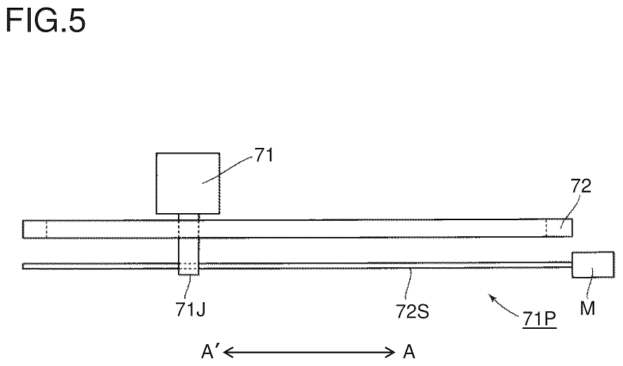

FIG. 5 is a side view schematically showing a movement portion 71P for moving the stapling portion 71 of the sheet binding unit 92. The movement portion 71P causes the stapling portion 71 to move in the sheet width direction. The movement portion 71P includes a support frame 72, a support portion 71J, a motor M, and a shaft 72S.

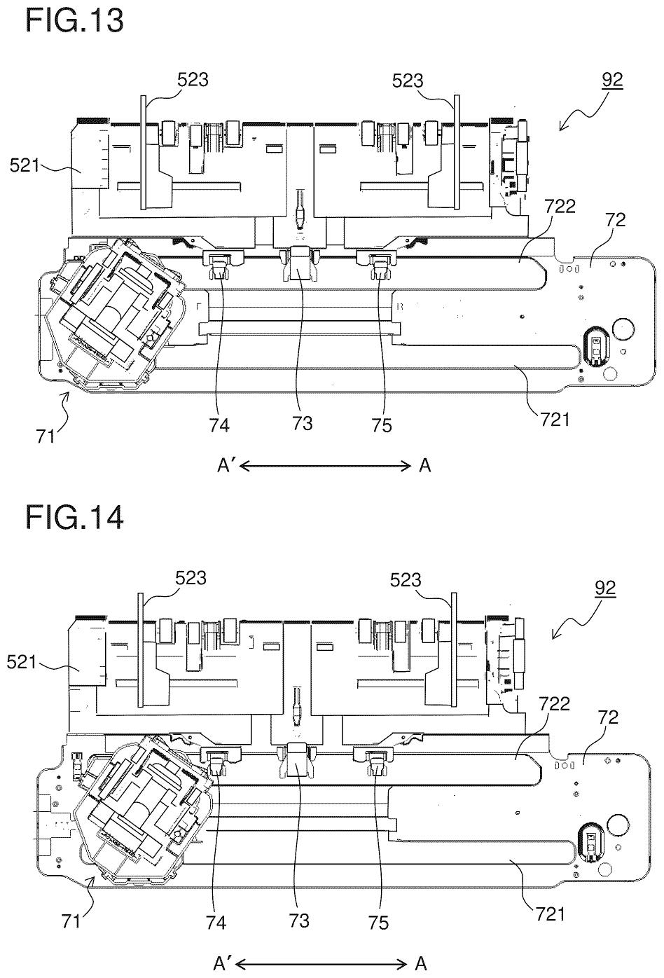

The support frame 72 is a rectangular sheet metal member extending in the sheet width direction and the sheet entry direction, and is disposed inside the sheet post-processing apparatus 1 so as to be adjacent to the processing tray 521. The support frame 72 includes a first guide groove 721 provided for movement of the stapling portion 71 and a second guide groove 722 provided for movements of the first reference plate 74 and the second reference plate 75 (for both see FIG. 13). The first guide groove 721 and the second guide groove 722 are elongated opening portions extending along the sheet width direction of the support frame 72.

The support portion 71J supports the stapling portion 71. The support portion 71J includes an unillustrated pair of shaft support portions. The pair of shaft support portions are respectively inserted in the first guide groove 721 and the second guide groove 722. The stapling portion 71 and the support portion 71J are integrally movable along the first guide groove 721 and the second guide groove 722 in the sheet width direction.

The motor M generates a driving force that causes the stapling portion 71 to move. The motor M generates rotational driving forces both in forward and reverse directions. The shaft 72S is coupled to the motor M to be caused to rotate by the driving force of the motor M. The shaft 72S has an unillustrated external thread formed on a circumferential surface thereof. At a lower end part of the support portion 71J, an unillustrated shaft hole is formed, and the shaft 72S is inserted in the shaft hole. The shaft hole of the support portion 71J has an unillustrated internal thread formed on an inner circumferential surface thereof. As a result, when the motor M causes the shaft 72S to rotate, the stapling portion 71 moves in the sheet width direction.

As described previously, in a case where oblique binding is performed on an end part of a bundle of sheets S, depending on a size of the sheets S on which the oblique binding is to be performed, a position for obliquely rotating the stapling portion 71 may overlap the first reference plate 74 or the second reference plate 75. As a result, when rotating, the stapling portion 71 may disadvantageously interfere with the first reference plate 74 or the second reference plate 75, which may prevent the stapling portion 71 from rotating and cause damage to the first reference plate 74 or the second reference plate 75.

To solve the above problem, in the present embodiment, the first reference plate 74 and the second reference plate 75 are caused to move in the sheet width direction along with the movement of the stapling portion 71. Next, a further detailed description will be given of a movement mechanism of the first reference plate 74 and the second reference plate 75.

### [4. Movement Mechanism of First Reference Plate and Second Reference Plate]

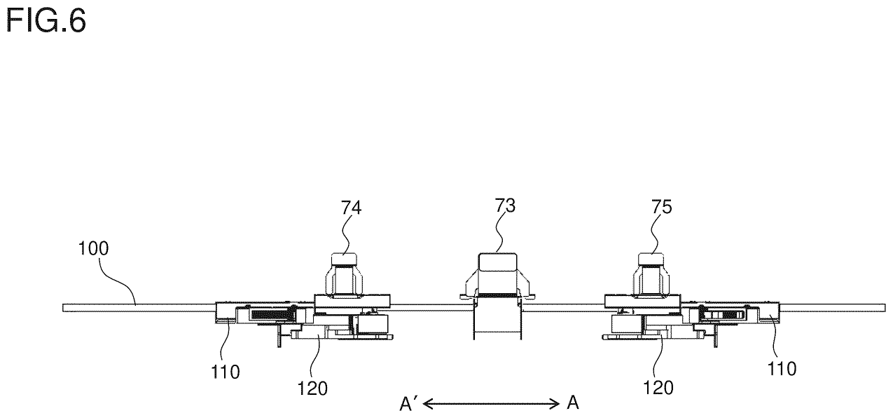

FIG. 6 is a side view of the central reference plate 73, the first reference plate 74, and the second reference plate 75 of the sheet binding unit 92, as seen from a downstream side (the rear right side in FIG. 3) in the alignment direction. As shown in FIG. 6, the central reference plate 73, the first reference plate 74, and the second reference plate 75 are supported by a support shaft 100 provided on a rear side of the processing tray 521.

The central reference plate 73 is swingable about the support shaft 100, and is restricted in movement in the sheet width direction (the arrow-AA′ direction). The first reference plate 74 and the second reference plate 75 are each supported, via a first slide member 110 and a second slide member 120, on the support shaft 100. The first reference plate 74 and the second reference plate 75 are movable in the sheet width direction.

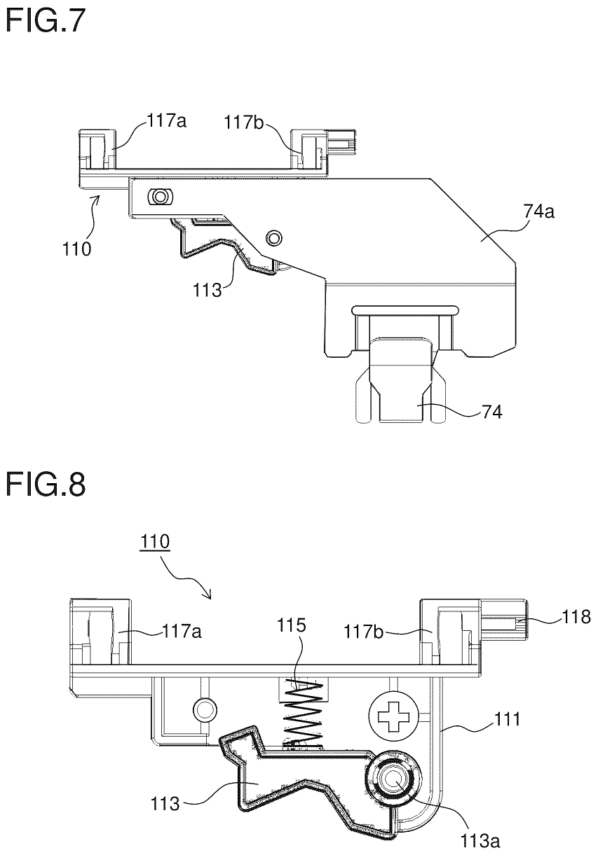

FIG. 7 is a plan view of a state in which the first reference plate 74 is mounted on the first slide member 110, as seen from a side of the first reference plate 74. FIG. 8 is a plan view showing an inner structure of the first slide member 110. Note that, although FIGS. 7 to 11 illustrate the first and second slide members 110 and 120 on which the first reference plate 74 is mounted, the first and second slide members 110 and 120 on which the second reference plate 75 is mounted also have completely identical configurations, except that they are in left-right symmetry with those on which the first reference plate 74 is mounted.

The first slide member 110 includes a main body portion 111, a first engagement member 113, and a compression spring 115. To the main body portion 111, a secured piece 74a, which is integrally formed with the first reference plate 74, is secured. On one edge (an upper end in FIG. 8) of the main body portion 111, guide portions 117a and 117b are formed in which the support shaft 100 is slidably inserted. In the guide portion 117b, a spring securing portion 118 is formed.

The first engagement member 113 is supported on the main body portion 111 so as to be swingable with a swing shaft 113a as a fulcrum. The compression spring 115 is disposed between the main body portion 111 and the first engagement member 113. The first engagement member 113 is biased by a biasing force of the compression spring 115 in a direction (a counterclockwise direction in FIG. 8) of protruding from the main body portion 111.

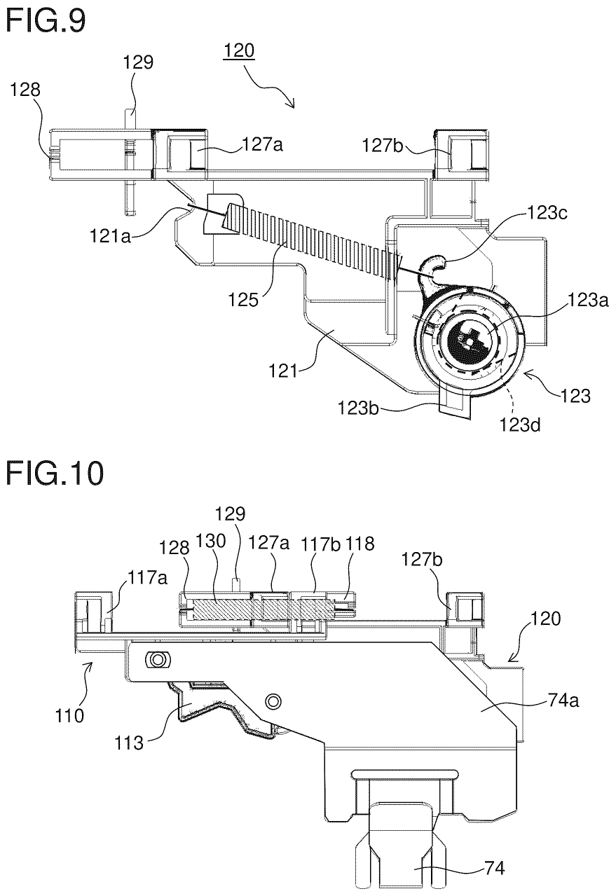

FIG. 9 is a plan view showing an inner structure of the second slide member 120. The second slide member 120 includes a main body portion 121, a second engagement member 123, and a tension spring 125. The main body portion 121 is coupled to the main body portion 111 of the first slide member 110 from a side (a rear side in FIG. 8) opposite to the first reference plate 74. On one edge (an upper end in FIG. 9) of the main body portion 121, guide portions 127a and 127b are formed in which the support shaft 100 is slidably inserted. In the guide portion 127a, a spring securing portion 128 and a restriction protrusion 129 are formed.

The second engagement member 123 is a cylindrical member that is supported on the main body portion 121 so as to be rotatable about a rotation shaft 123a. The second engagement member 123 includes an engagement protruding portion 123b and a hook portion 123c. The engagement protruding portion 123b protrudes in a radial direction of the second engagement member 123. The hook portion 123c protrudes in a radial direction of the second engagement member 123 from a position different from the engagement protruding portion 123b in a circumferential direction of the second engagement member 123.

The tension spring 125 is coupled to a spring hooking portion 121a of the main body portion 121 and to the hook portion 123c of the second engagement member 123. The second engagement member 123 is biased by a biasing force of the tension spring 125, in a direction (a counterclockwise direction in FIG. 9) in which the engagement protruding portion 123b protrudes from the main body portion 121.

Inside the second engagement member 123, a torsion spring 123d is disposed. The second engagement member 123 is divided, in a direction of the rotation shaft 123a, into a part that includes the engagement protruding portion 123b and a part that includes the hook portion 123c. The torsion spring 123d biases the part including the engagement protruding portion 123b in a clockwise direction.

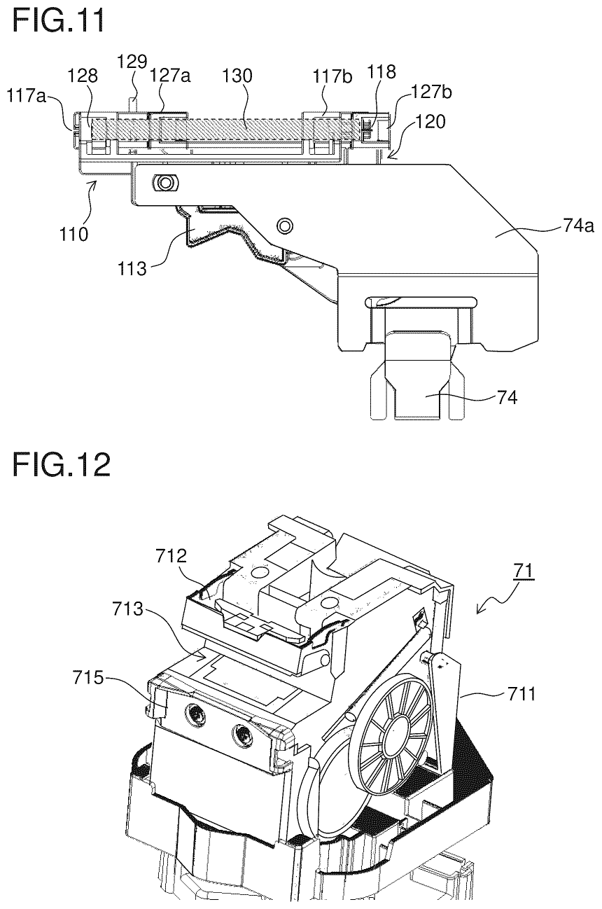

FIG. 10 and FIG. 11 are plan views of a state in which the first slide member 110 and the second slide member 120 are coupled to each other, as seen from the side of the first reference plate 74. The second slide member 120 is coupled so as to be slidable with respect to the first slide member 110 in an axial direction of the support shaft 100 (a left-right direction in FIGS. 10 and 11). That is, the first slide member 110 and the second slide member 120 are coupled to each other such that a distance therebetween is changeable in the axial direction of the support shaft 100.

Between the first slide member 110 and the second slide member 120, a slide spring 130 is disposed. The slide spring 130 is a tension spring, and opposite end parts of the slide spring 130 are respectively secured to the spring securing portion 118 of the first slide member 110 and the spring securing portion 128 of the second slide member 120.

FIG. 10 shows a state in which the slide spring 130 is in a contracted state, which is a normal state thereof. In the state shown in FIG. 10, due to a biasing force of the slide spring 130, the guide portion 117b of the first slide member 110 and the guide portion 127a of the second slide member 120 abut each other. That is, when in the state shown in FIG. 10, the first slide member 110 and the second slide member 120 are at their maximum separation from each other.

FIG. 11 shows a state in which the slide spring 130 is in an expanded state. In the state shown in FIG. 11, against the biasing force of the slide spring 130, the guide portion 117b and the guide portion 127a are separated from each other, with the guide portion 117a and the guide portion 117b abutting the guide portion 127a and the guide portion 127b, respectively.

FIG. 12 is a perspective view of the stapling portion 71 as seen from a side of the processing tray 521. The stapling portion 71 includes a stapling-side engagement portion 715, which is disposed on a side surface of the stapling main body 711 that faces the first slide member 110 and the second slide member 120. The stapling-side engagement portion 715 makes contact with the first engagement member 113 and the second engagement member 123 when the stapling portion 71 moves in the sheet width direction.

As will be described later, while the stapling portion 71 moves outward (toward the apparatus front side) in the sheet width direction from a central part (an apparatus center), when an external force is applied by the stapling portion 71 to the first reference plate 74, as shown in FIG. 11, the slide spring 130 is caused to expand against the biasing force, causing the first slide member 110 and the second slide member 120 to move in directions of approaching each other.

[5. Movement of First and Second Reference Plates Along with Movement of Stapling Portion]

Next, a description will be given of a mechanism by which the first reference plate 74 and the second reference plate 75 is caused to move as the stapling portion 71 moves. FIG. 13 is a plan view of the sheet binding unit 92 as seen from above, showing a state in which the stapling portion 71 is disposed at a reference position.

As shown in FIG. 13, the stapling portion 71 is disposed at the reference position (a home position, which is on the apparatus front side in the present embodiment) in an inclined state inclined by a predetermined angle with respect to the sheet width direction (the arrow-AA′ direction), along which the central reference plate 73, the first reference plate 74, and the second reference plate 75 are aligned. The first reference plate 74 and the second reference plate 75 are disposed at initial positions, with the guide portion 127b abutting a central restriction portion 723 (see FIG. 16).

In a case of performing a stapling process on a bundle of sheets S, before the sheets S are conveyed onto the processing tray 521, the stapling portion 71 is moved from the reference position (the home position) to a predetermined stapling position (a position for driving a staple needle through the sheets S).

For example, in a case of oblique binding of binding sheets S with a staple needle driven through the sheets S at a corner thereof in an oblique manner, the motor M as a drive source for moving the stapling portion 71 is caused to rotate, whereby, via a deceleration mechanism and a drive transmission gear (of which neither is illustrated), the shaft 72S is caused to rotate by a predetermined amount. Thereby, the stapling portion 71 is moved in an inclined state.

FIG. 14 is a diagram showing a standby position of the stapling portion 71 for performing oblique binding on A-sized sheets S. In a case of performing oblique binding with respect to A-sized (e.g., portrait A4) sheets having a width-direction dimension that is greater than the distance between the first reference plate 74 and the second reference plate 75 disposed at the initial positions, as shown in FIG. 14, the stapling portion 71 moves from the reference position in the arrow-A direction and stops at the stapling position without passing by the first reference plate 74.

In this state, the A-sized sheets S conveyed from the image forming apparatus 200 are stacked and aligned one by one on the processing tray 521, and then a staple needle is obliquely driven through the sheets S as a bundle at a corner thereof on the apparatus front side (in the arrow-A′ direction), whereby the sheets S are bound together. After the oblique binding is finished, the motor M is caused to rotate reversely to thereby return the stapling portion 71 to the reference position (see FIG. 13).

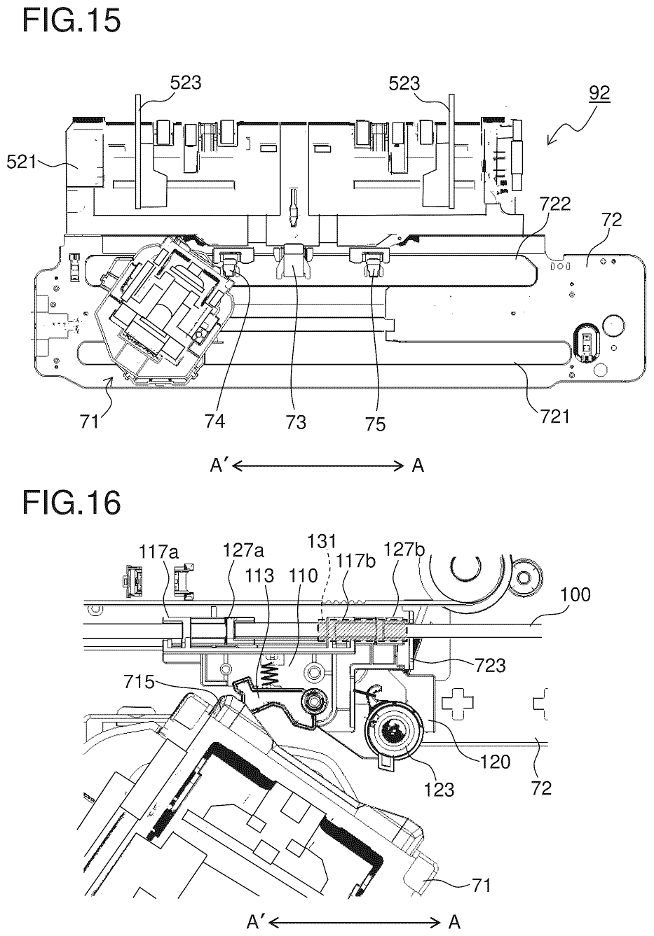

FIG. 15 is a diagram showing a standby position of the stapling portion 71 for performing oblique binding on B-sized sheets S. FIG. 16 is a partial enlarged view showing insides of the first slide member 110 and the second slide member 120 of the first reference plate 74 in the state shown in FIG. 15. As shown in FIG. 16, between the second slide member 120 and the support frame 72, a biasing spring 131 is coupled. The biasing spring 131 is a tension spring, and biases the second slide member 120 toward the apparatus center (in the arrow-A direction). Due to a biasing force of the biasing spring 131, the guide portion 127b of the second slide member 120 abuts the central restriction portion 723 formed on the support frame 72.

In a case of binding B-sized (e.g., portrait-B5) sheets S having a widthwise size that is less than the distance between the first reference plate 74 and the second reference plate 75 disposed at the initial positions, the stapling portion 71 in the inclined state moves from the apparatus front side toward the apparatus center, and during the movement, as shown in FIG. 16, the stapling-side engagement portion 715 provided on the stapling portion 71 makes contact with the first engagement member 113 of the first slide member 110 that is coupled to the first reference plate 74 disposed at the initial position.

Then, as the stapling portion 71 moves, the stapling-side engagement portion 715 presses the first engagement member 113, thereby causing the first slide member 110 to move in a direction of overlapping the second slide member 120 while expanding the slide spring 130 (see FIG. 10). That is, the first slide member 110 moves to shift from the state shown in FIG. 10 into the state shown in FIG. 11. As a result, the first reference plate 74 also moves from the initial position toward the apparatus center (in the arrow-A direction). The stapling portion 71, while causing the first reference plate 74 to move, stops at the predetermined stapling position.

In this state, B-sized sheets S conveyed from the image forming apparatus 200 are aligned and stacked one by one on the processing tray 521 into a bundle, and a staple needle is obliquely driven through the bundle of sheets S in a corner thereof on the apparatus front side (in the arrow-A′ direction), thereby binding the bundle of sheets S. After the oblique binding is completed, the motor M is caused to rotate reversely to return the stapling portion 71 to the reference position (see FIG. 13). Further, since the stapling-side engagement portion 715 separates from the first engagement member 113, the first slide member 110 is caused by a restoring force of the slide spring 130 to move toward the apparatus front side (in the arrow-A′ direction) to return to the initial position.

Next, a description will be given of a case where parallel binding of binding sheets S by driving a staple needle therethrough so as to be parallel to an edge of the sheets S along the width direction thereof (an apparatus front-rear direction) is performed on B-sized sheets S having a widthwise size that is less than the distance between the first reference plate 74 and the second reference plate 75. There are two types of parallel binding: one-point binding, where sheets S are bound at a single point in a corner of an edge of the sheets S; and two-point binding, where sheets S are bound at two points along an edge of the sheets S.

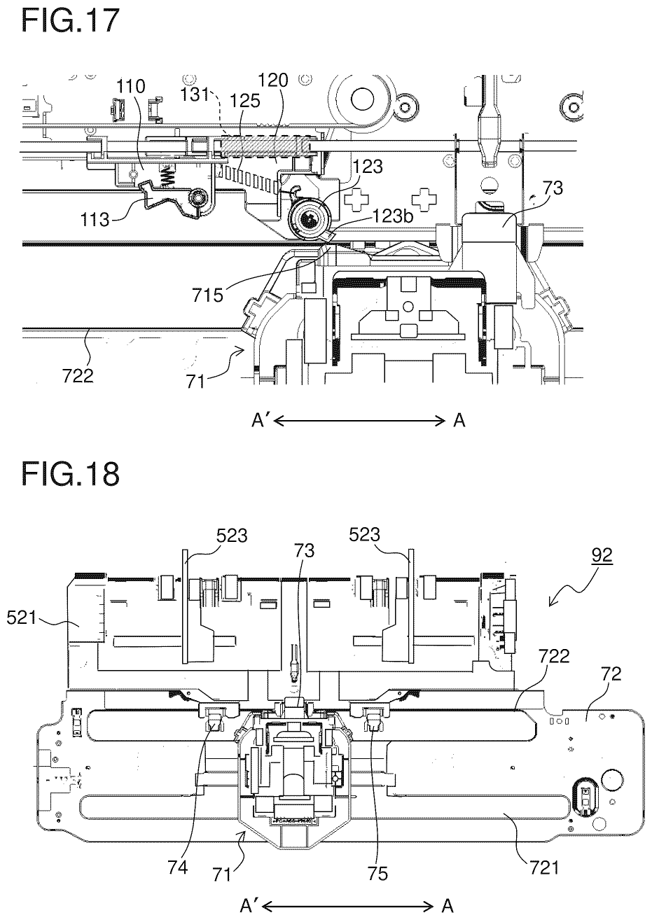

FIG. 17 is a partial enlarged view showing the insides of the first slide member 110 and the second slide member 120 of the first reference plate 74 in a state in which the stapling portion 71 is moving from the reference position to the stapling position for performing parallel binding on B-sized sheets S. FIG. 18 is a diagram showing a standby position of the stapling portion 71 in a case of performing parallel binding on B-sized sheets S.

While the stapling portion 71 disposed at the reference position in an inclined state moves from the apparatus front side toward the apparatus center, as shown in FIG. 16, the stapling-side engagement portion 715 provided on the stapling portion 71 makes contact with the first engagement member 113 of the first slide member 110 coupled to the first reference plate 74 disposed at the initial position. Furthermore, the stapling-side engagement portion 715 presses the first engagement member 113 toward the apparatus center, thereby causing the first reference plate 74 to move in the direction (the arrow-A direction) toward the apparatus center as the stapling portion 71 moves.

When the stapling portion 71 moves to a predetermined position, the angle of the stapling portion 71 changes, along shapes of the first guide groove 721 and the second guide groove 722 that guide the movement of the stapling portion 71, so that the stapling portion 71 shifts to a parallel state parallel to a movement direction thereof. Thereby, the stapling-side engagement portion 715 and the first engagement member 113 are disengaged from each other, and the first reference plate 74 returns to the initial position due to the restoring force of the slide spring 130.

Thereafter, when the stapling portion 71 moves further toward the apparatus center, as shown in FIG. 17, the stapling-side engagement portion 715 makes contact with the engagement protruding portion 123b of the second engagement member 123 provided on the second slide member 120. Here, the part of the second engagement member 123 that includes the engagement protruding portion 123b is biased by the torsion spring 123d (see FIG. 9) with a biasing force of such a magnitude that does not prevent the stapling portion 71 from moving but allows the engagement protruding portion 123b to return to the original position. Thus, the stapling portion 71 moves toward the apparatus center, causing the part including the engagement protruding portion 123b to rotate counterclockwise. That is, the contact between the second engagement member 123 and the stapling-side engagement portion 715 does not affect the movement of either the stapling portion 71 or the first reference plate 74.

As shown in FIG. 18, after the stapling portion 71 in the parallel state is stopped at a predetermined standby position, B-sized sheets S conveyed from the image forming apparatus 200 are aligned and stacked one by one on the processing tray 521, and the stapling portion 71 is caused to move to a predetermined position in the width direction of the bundle of sheets S so as to parallelly drive a staple needle through the sheets S at one point, thereby binding the bundle of sheets S. After the parallel binding is completed, the motor M is caused to rotate reversely to return the stapling portion 71 to the reference position (see FIG. 13).

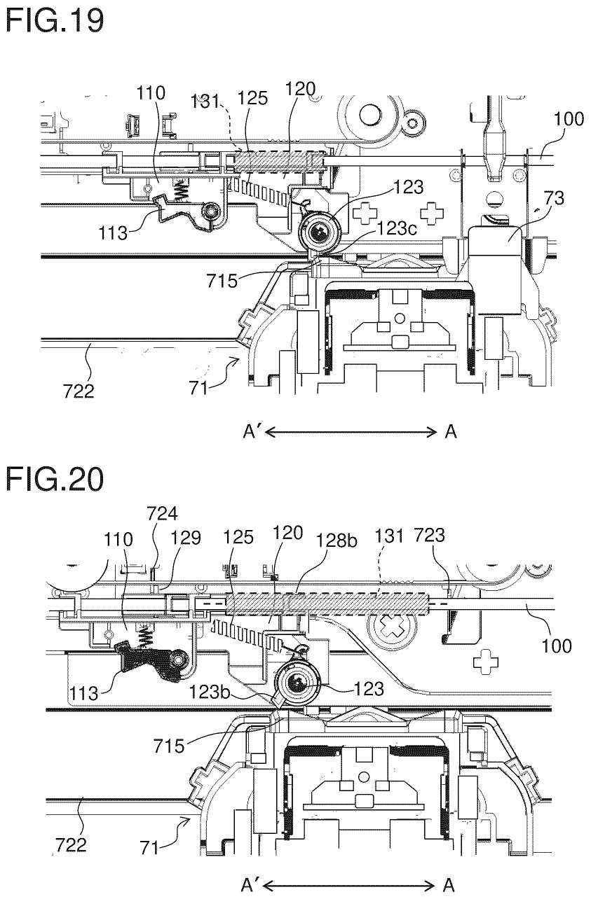

FIG. 19 is a diagram showing a state in which, while the stapling portion 71 returns from the apparatus center to the reference position, the stapling-side engagement portion 715 and the engagement protruding portion 123b of the second engagement member 123 have made contact with each other. After the sheets S are received, when the stapling portion 71 is moved to a predetermined position, while the stapling portion 71 in the parallel state moves toward the apparatus front side (in the arrow-A′ direction), the stapling-side engagement portion 715 comes into engagement with the engagement protruding portion 123b of the second engagement member 123. Thus, the second engagement member 123 receives a counterclockwise pressing force acting thereon. On the other hand, the second engagement member 123 is biased counterclockwise by the tension spring 125.

The biasing force of the tension spring 125 (a rotation restriction force restricting clockwise rotation of the second engagement member 123) is greater than the biasing force of the biasing spring 131 biasing the second slide member 120 from the apparatus front side toward the apparatus center. Thus, due to the movement of the stapling portion 71, the second slide member 120 moves from the initial position toward the apparatus front side, causing the biasing spring 131 to expand. As a result, together with the second slide member 120, the first slide member 110 and the first reference plate 74 can be moved toward the apparatus front side.

FIG. 20 is a diagram showing a state in which, due to the movement of the stapling portion 71 from the state shown in FIG. 19, the second engagement member 123 has started to rotate. When the first reference plate 74 moves toward the apparatus front side by a predetermined amount, the restriction protrusion 129 formed on the guide portion 127a of the second slide member 120 abuts an end-part restriction portion 724 formed on the support frame 72. As a result, although the stapling portion 71 is allowed to move toward the apparatus front side, the second slide member 120 is restricted, by the end-part restriction portion 724, from movement toward the apparatus front side.

Thus, as shown in FIG. 20, the second engagement member 123 rotates clockwise against the rotation restriction force of the tension spring 125, so that the engagement protruding portion 123b and the stapling-side engagement portion 715 become disengaged from each other. Thereby, due to the biasing force (a restoring force) of the biasing spring 131, the second engagement member 123 moves in the direction (the arrow-A direction) toward the apparatus center, and the guide portion 127b of the second slide member 120 abuts against the central restriction portion 723, thereby causing the first reference plate 74 to return to the initial position.

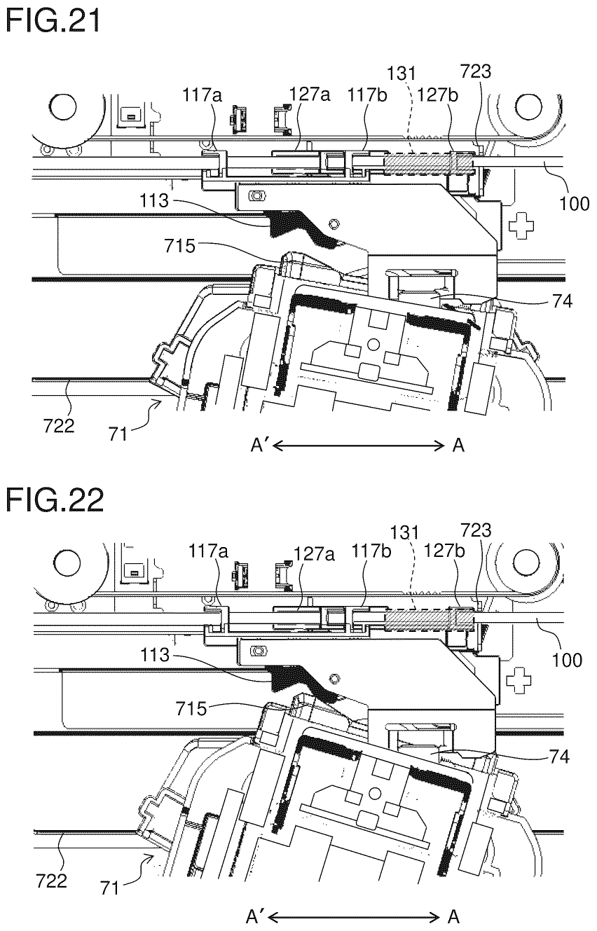

FIG. 21 is a diagram showing a state in which the stapling portion 71 has moved from the state shown in FIG. 20 toward the apparatus front side, until the stapling portion 71 and the first reference plate 74 overlap each other. When the stapling portion 71 in the state shown in FIG. 20 further moves (in the arrow-A′ direction) toward the apparatus front side, the stapling portion 71 and the first reference plate 74 overlap each other. At this time, along the shapes of the first guide groove 721 and the second guide groove 722, the stapling portion 71 starts to rotate to shift from the parallel state to the inclined state.

When the stapling portion 71 rotates by a predetermined angle from the state shown in FIG. 21, as shown in FIG. 22, the stapling-side engagement portion 715 provided on the stapling portion 71 abuts the first engagement member 113 of the first slide member 110.

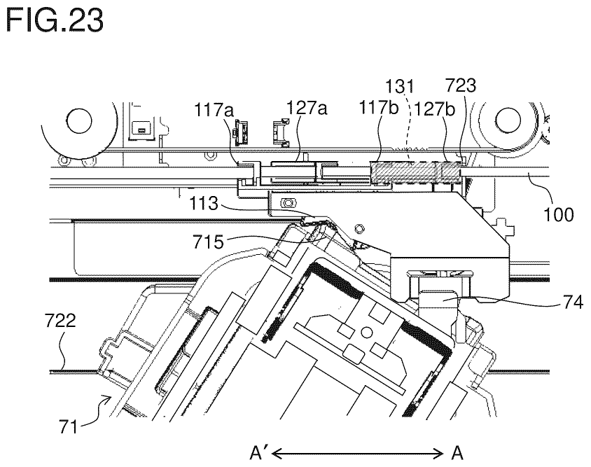

When the stapling portion 71 further rotates from the state shown in FIG. 22, the stapling-side engagement portion 715 presses the first engagement member 113 as shown in FIG. 23. Thereby, the first slide member 110 moves toward the apparatus center (in the arrow-A direction), causing the slide spring 130 to expand, and, together with the first slide member 110, the first reference plate 74 moves in a direction (the arrow-A direction) opposite to the movement direction of the stapling portion 71.

Thereafter, due to the movement of the stapling portion 71 toward the apparatus front side (in the arrow-A′ direction), the stapling-side engagement portion 715 separates from the first engagement member 113, and the stapling portion 71, in the inclined state, returns to the reference position. The first slide member 110 moves toward the apparatus front side (in the arrow-A′ direction) due to the biasing force (the restoring force) of the slide spring 130, and the first reference plate 74 returns to the initial position.

According to the configuration described above, it is possible to dispose the first reference plate 74 at positions necessary for executing oblique binding, one-point binding, and two-point binding, and to avoid interference between the stapling portion 71 and the first reference plate 74. This makes it possible to execute stable stapling on sheets S without degrading the alignment of the sheets S.

Further, when the stapling portion 71 rotates, the first reference plate 74 is unlikely to interfere with the stapling portion 71 or block the rotation of the stapling portion 71, and thus it is also possible to protect the first reference plate 74 from deformation and damage. Further, since there is no need for a drive source for moving the first reference plate 74, it is possible to provide the high-alignment sheet binding unit 92 at a low price.

The above-described embodiment is by no means meant to limit the scope of the present disclosure, and various modifications can be made and implemented within the scope not departing from the gist of the invention. For example, although, in the above-described embodiment, the description was given of the movement of the first reference plate 74 along with the movement of the stapling portion 71 with the apparatus front side as the reference position of the stapling portion 71, the movement of the second reference plate 75 along with the movement of the stapling portion 71 with the apparatus rear side as the reference position of the stapling portion 71 can also be described in a totally identical manner.

Further, in the above-described embodiment, as the movement portion 71P for moving the stapling portion 71, a configuration has been described in which the stapling portion 71 is caused to reciprocate due to the rotation of the shaft 72S, but this is not meant to limit the present disclosure. The movement portion 71P may have a configuration in which, instead of the shaft 72S, a mechanism including a wire, a belt, or the like suspended around pulleys is used to cause the stapling portion 71 to reciprocate.

Further, in the above-described embodiment, a configuration has been described which includes, as the reference plates for aligning sheets S in the sheet entry direction, the central reference plate 73 and the pair of the first and second reference plates 74 and 75 disposed with the predetermined distance therebetween in the sheet width direction so as to sandwich the central reference plate 73, but a configuration may be adopted that includes only either the first reference plate 74 or the second reference plate 75. Alternatively, three or more movable reference plates may be provided.

The present disclosure is applicable to a sheet binding device that performs binding process on a plurality of sheets, and to a sheet post-processing apparatus including the sheet binding device.

What is claimed is:

1. A sheet binding device, comprising:
a processing tray on which a plurality of sheets conveyed thereto along a predetermined sheet entry direction are stacked;
a movable reference plate that is disposed at a predetermined initial position at which the movable reference plate is capable of aligning the sheets by abutting edges of the sheets on a downstream side in an alignment direction that is opposite to the sheet entry direction, the movable reference plate being movable from the initial position in a sheet width direction that is orthogonal to the sheet entry direction;
a stapling portion that is disposed opposite to the edges of the sheets, and that performs a stapling process of binding the plurality of sheets stacked on the processing tray with a staple needle at a predetermined position;
a movement portion that causes the stapling portion to move, along the edges of the sheets, to a reference position that is located outward of the initial position in the sheet width direction and to at least one stapling position that is located inward of the initial position in the sheet width direction and at which the staple process is performed;
a slide member on which the movable reference plate is mounted and that is reciprocatable along the sheet width direction; and
a slide spring that biases the slide member in a direction in which the movable reference plate approaches the initial position,
wherein
the movement portion is capable of shifting orientation of the stapling portion to an inclined state inclined with respect to the edges of the sheets and to a parallel state parallel to the edges of the sheets,
the slide member includes a movable engagement member that makes contact with a stapling-side engagement portion of the stapling portion when the stapling portion moves between the reference position and the stapling position,
in a state in which the movable reference plate is disposed at the initial position, when the stapling portion is brought into the inclined state and moved from the reference position to the stapling position, the stapling-side engagement portion presses the movable engagement member, thereby causing the movable reference plate to move with the slide member inward in the sheet width direction against a biasing force of the slide spring,
when the orientation of the stapling portion is shifted from the inclined state to the parallel state before the stapling portion reaches the stapling position, the stapling-side engagement portion separates from the movable engagement member, thereby causing the movable reference plate to move with the slide member outward in the sheet width direction due to the biasing force of the slide spring, so as to return to the initial position,
when the orientation of the stapling portion is shifted from the parallel state to the inclined state while the stapling portion is moved from the stapling position to the reference position, the stapling-side engagement portion presses the movable engagement member, thereby causing the movable reference plate to move with the slide member inward from the initial position in the sheet width direction against the biasing force of the slide spring, and
due to movement of the stapling portion to the reference position, the stapling-side engagement portion separates from the movable engagement member, thereby causing the movable reference plate to move with the slide member outward in the sheet width direction due to the biasing force of the slide spring, so as to return to the initial position.

2. The sheet binding device according to claim 1,
wherein
the slide member includes
a first slide member to which the movable reference plate is secured, and
a second slide member that is coupled to the first slide member in such a manner as to be movable in the sheet width direction,
the slide spring exerts a biasing force in a direction in which the first slide member and the second slide member separate from each other in the sheet width direction,
the movable engagement member includes a first engagement member that is provided on the first slide member and swingable in a direction perpendicular to a movement direction of the stapling portion,
while the stapling portion in the inclined state moves from the reference position to the stapling position, the stapling-side engagement portion presses the first engagement member in the moving direction, thereby causing the movable reference plate to move with the first slide member and the second slide member inward in the sheet width direction, and when the orientation of the stapling portion is shifted from the inclined state to the parallel state, the stapling-side engagement portion separates from the first engagement member, thereby causing the movable reference plate to return to the initial position due to the biasing force of the slide spring, and
when the orientation of the stapling portion is shifted from the parallel state to the inclined state while the stapling portion is moved from the stapling position to the reference position, the stapling-side engagement portion presses and swings the first engagement member in a direction perpendicular to the movement direction, thereby allowing the orientation of the stapling portion to be shifted to the inclined state and causing the movable reference plate to move with the first slide member inward in the sheet width direction.

3. The sheet binding device according to claim 2, further comprising a biasing spring that biases the second slide member toward a center in the sheet width direction,
wherein
the movable engagement member includes a second engagement member that is provided on the second slide member and that is rotatable along the movement direction of the stapling portion when receiving a predetermined rotational load or higher,
when the second slide member moves to a predetermined restriction position while the stapling portion moves from the reference position to the stapling position, and, with the movable reference plate disposed at the initial position, the stapling-side engagement portion comes into engagement with the second engagement member, the second engagement member rotates, thereby allowing the stapling portion to move to the stapling position without moving the movable reference plate from the initial position,
while the stapling portion moves from the stapling position to the reference position, when the stapling-side engagement portion comes into engagement with the second engagement member, with the movable reference plate disposed at the initial position, the second engagement member is pressed without being caused to rotate, thereby causing the first slide member and the second slide member to move outward in the sheet width direction, and
when the first slide member and the second slide member move and reach a predetermined restriction position, the second engagement member rotates to disengage the stapling-side engagement portion and the second engagement member from each other, thereby causing the movable reference plate to return to the initial position with the first slide member and the second slide member due to a biasing force of the biasing spring.

4. The sheet binding device according to claim 1,
wherein
the movable reference plate includes a first reference plate and a second reference plate that are disposed with a distance therebetween in the sheet width direction,
a secured reference plate is included that is disposed between the first reference plate and the second reference plate, that is restricted from movement in the sheet width direction, and that is swingable in a direction perpendicular to the sheet width direction, and
the reference position of the stapling portion is located outward of the initial position of the first reference plate or of the second reference plate in the sheet width direction.

5. The sheet binding device according to claim 1,
wherein
the movement portion includes
a motor that causes the stapling portion to reciprocate in the sheet width direction and
a support frame in which a guide groove is formed as a movement path for the stapling portion, and
the orientation of the stapling portion is shifted to the inclined state and to the parallel state along a shape of the guide groove.

6. The sheet binding device according to claim 1,
wherein
the stapling process includes
oblique binding of binding the sheets by driving a staple needle obliquely through the sheets in a corner part of the sheets, and
a parallel binding of binding the sheets by driving the staple needle through the sheets parallel to the edges of the sheets, and
the stapling portion is disposed at the stapling position in the inclined state in a case of performing the oblique binding, and is disposed at the stapling position in the parallel state in a case of performing the parallel binding.

7. A sheet post-processing apparatus comprising the sheet binding device according to claim 1.
